(19) United States
(12) Patent Application Publication
(10) Pub. No.: US 2013/0152863 A1
(43) Pub. Date: Jun. 20, 2013

(54) Collapsible disposable cardboard container

(71) Applicant: David W. Peterson, San Diego, CA (US)

(72) Inventor: David W. Peterson, San Diego, CA (US)

(21) Appl. No.: 13/328,996

(22) Filed: Dec. 16, 2011

(51) Int. Cl. A01K 29/00

(52) U.S. Cl. 119/168

(57) ABSTRACT

A cardboard container can be folded into a compact flat package for storage, shipment or disposal. The container can be locked into an open configuration by a pair of stiffening lappets removably wedged in folds into pockets of the collapsible side walls. The container is particularly adapted to hold cat litter or other disposable material.

### FIELD OF THE INVENTION

The invention relates to cardboard containers and more specifically to disposable cat litter boxes.

### BACKGROUND

For centuries pet owners have had to contend with pet waste especially for indoor pets. Cat litter boxes have likely existed for almost as long, but present certain problems. Reusable cat litter trays and boxes must be emptied and cleaned at frequent intervals. The task is most unpleasant, malodorous, and subject to untidy spillage. Further, after cleaning unpleasant residues often remain.

The problem is often magnified for pet owners who desire to bring their pets along when traveling. Litter boxes are often bulky and impractical to transport. Purchasing a new litter box while traveling can often be difficult and expensive.

Various collapsible and disposable boxes have been proposed which ostensibly can be conveniently collapsed and folded for storage, shipment and eventual discarding. However, devices including those described by Mesly, U.S. Pat. No. 7,255,261; Blaszak et al., U.S. Pat. No. 6,698,382; and Robinson, U.S. Pat. No. 5,845,601 can be difficult and time-consuming to assemble and/or collapse, have limited structural stability, and remain subject to spillage.

There is a need for an inexpensive disposable cat litter container that addresses one or more of the above problems.

### SUMMARY

The principal and secondary objects of the invention are to provide improved collapsible, disposable litter box.

These and other objects are achieved by a collapsible and foldable box of disposable material having conveniently actuated support structures.

In some embodiments there is provided a collapsible and foldable cardboard box made of a single, non-porous cardboard sheet cut and scored with folding creases to form a rectangular bottom piece, a front wall, a back wall, a pair of side walls and a cover flap. In some embodiments each side wall is scored by two oblique crease lines converging in the middle of the top edge, in order to induce and allow inward collapsing of the side walls and folding of the front and back walls. In some embodiments a strip extending from the top edge of each side wall is folded inwardly and glued down against the inner surface, except about a small median, triangular area in order to form a pocket. In some embodiments a small lappet appended to the lower edge of the pocket is folded and inserted into the pocket to act as a stiffening member that prevent the side wall from collapsing and the whole structure from folding down. In some embodiments a layer of cat litter is held over the bottom piece. In some embodiments the cover flap is hingedly connected to the top edge of the back wall, and has a strip of adhesive for sealing the collapsed package. In some embodiments the structure can then be folded about a pair of front-to-back median parallel crease lines for convenient disposal.

In some embodiments there is provided a collapsible structure which comprises: a front wall; a back wall; a pair of side walls spanning said front and back walls about four orthogonal corners; each of said side walls having an upper edge and a pair of oblique creases each extending from a lower part of one of said corners to a central region of said upper edge; and a removable stiffening member preventing each of said side walls from folding down along said creases.

In some embodiments each of said side walls further includes: a flap extending from said upper edge and fixedly folded over a triangular top portion of said wall delineated by said creases; and, said stiffening member being wedged between said flap and said triangular portion.

In some embodiments said triangular top portion and said flap cooperatively form a pocket shaped and dimensioned to intimately accept said stiffening member.

In some embodiments the structure further comprises a lappet hingedly connected to said flap, wherein said lappet comprises said stiffening member.

In some embodiments said lappet comprises: a pair of parallel folding lines defining a blocking strip therebetween; and, a floating handling tab.

In some embodiments said stiffening member comprises said blocking strip.

In some embodiments the structure further comprises a rectangular bottom joined to said walls along its periphery.

In some embodiments the structure further comprises a cover hingedly connected to an upper edge of one of said front and back walls.

In some embodiments the structure further comprises a seal for sealing said cover over said collapsed structure.

In some embodiments said seal extends along the entire width of said structure.

In some embodiments the structure further comprises a layer of granular litter material over said bottom.

In some embodiments the structure further comprises a first folding crease extending across a median portion of said cover, front wall, back wall and bottom.

In some embodiments the structure further comprises a second folding crease parallel to said first folding crease and spaced sufficiently apart therefrom to allow said structure collapsed along said oblique lines and said periphery to be folded about said first and second creases in a substantially planar manner.

The content of the original claims is incorporated herein by reference as summarizing features in one or more exemplary embodiments.

### BRIEF DESCRIPTION OF THE DRAWINGS

FIG. 1 is a perspective view of a collapsible disposable container structure according to an exemplary embodiment of the invention.

FIG. 2 is a top plan view of the construction sheet of the structure of FIG. 1 prior to assembly.

FIG. 3 is a cross-sectional view of the locking lappet in the locking position taken along line 3-3 of FIG. 1.

FIG. 4 is a cross-sectional view of the locking lappet in the unlocking position.

FIG. 5 is a perspective view of the collapsible disposable container structure of FIG. 1 in the collapsed condition.

FIG. 6 is a top front right side oblique view of a disposable cat litter structure showing represented as an ornamental design of a cat litter box.

FIG. 7 is a bottom back left side oblique view of the design of FIG. 6.

FIG. 8 is a front elevational view of the design of FIG. 6.

FIG. 9 is a back elevational view of the design of FIG. 6.

FIG. 10 is a right side elevational view of the design of FIG. 6.

FIG. 11 is a left side elevational view of the design of FIG. 6.

FIG. 12 is a top plan view of the design of FIG. 6.

FIG. 13 is a bottom plan view of the design of FIG. 6.

### DESCRIPTION OF THE EXEMPLARY EMBODIMENTS

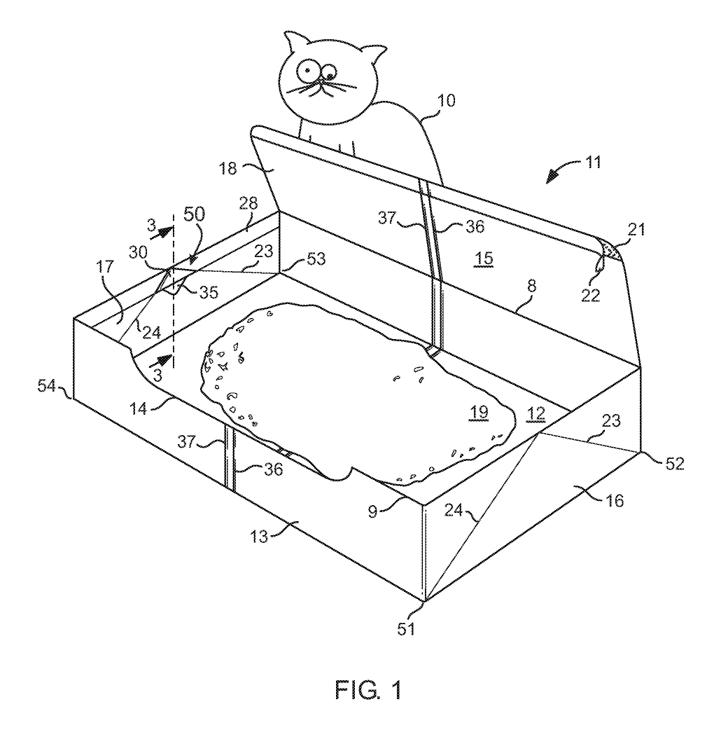

Referring now to the drawing, there is shown in FIG. 1 a container structure, in this case a litter box 11 adapted to be used by a cat 10. The structure can be made out a single sheet of a wax-impregnated cardboard or other inexpensive, easily cut and folded, disposable, semi-rigid sheet material that is substantially non-porous so that it is resistant or impervious to becoming saturated or permeated by liquid. The preferred material is Earthboard brand material available from Smart Planet Technologies, Inc. of Irvine, California. The box comprises a bottom piece 12, a front wall 13 having a partial cutout 14 along its top edge 9 to facilitate access, a back wall 15, a pair of side walls 16, 17, spanning the front and back walls about four orthogonal corners 51-54 and a cover flap 18 hingedly secured to the top edge 8 of the back wall. A layer 19 of granular litter material is laid over the bottom piece.

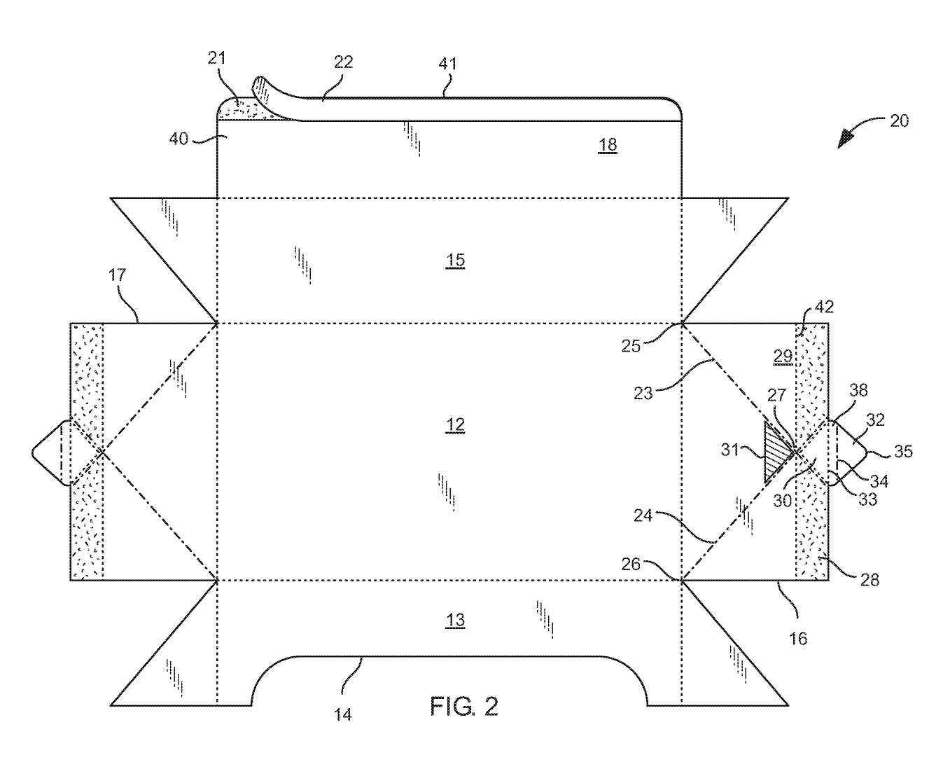

As shown in FIG. 2, the structure is made out of a single sheet 20, cut and scored with a plurality of folding creases. The dotted lines in the drawing indicate prefolded or score lines for inward folding, and the dash-dotted lines indicate score lines for outward folding.

A strip of adhesive 21 protected by a removable film 22 is applied to the inside surface 40 of the cover flap 18 near its top edge 41 laterally extending the entire width of the back wall. In this way, after use, the structure can be returned to its collapsed configuration enclosing the granular litter material and sealed by removing the film and sealing the cover flap to the front wall. Care should be taken in dimensioning the bottom piece, front and back walls, the cover flap and the top-to-bottom depth of the cutout 14 so that the adhesive layer can contact along the entire width of the front wall and thus help seal the collapsed structure from spillage.

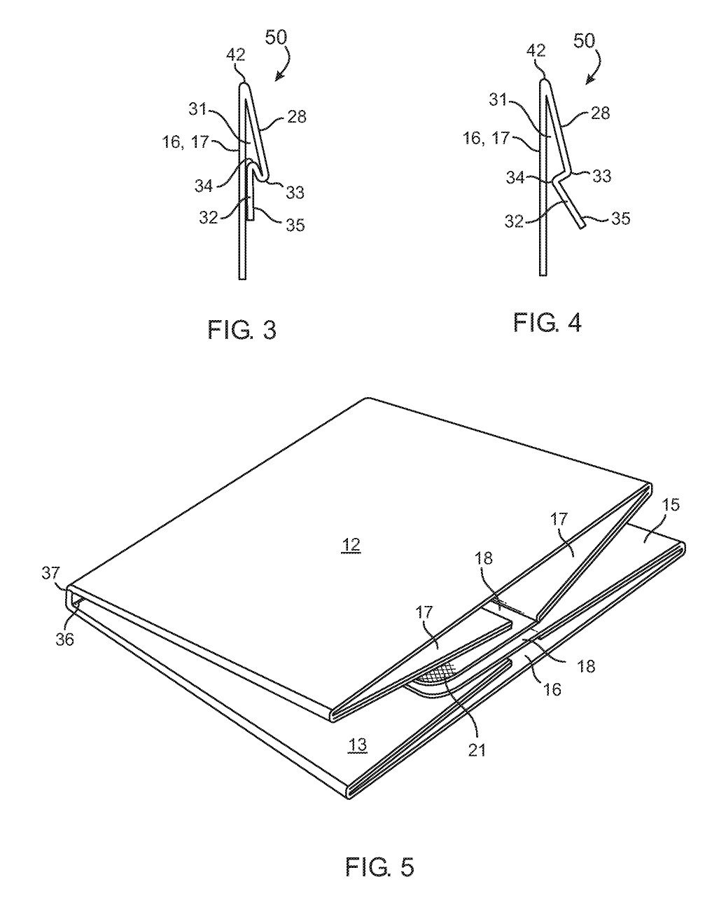

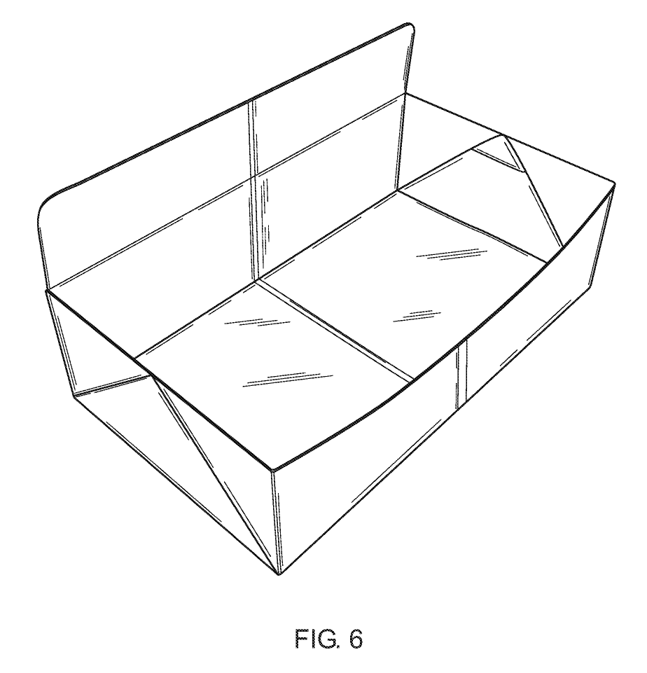

In each side wall 16, 17, a pair of oblique, outwardly-folding creases 23, 24 run from a lower corner 25, 26 of the wall to a central region 27 of what will become its upper edge when inwardly folded on line 42. A flap 28 extending from the top edge 42 is coated with glue and folded along line 42 against the inner wall surface 29 of the side wall, except for a small median, triangular area 30 which remains unglued and forms a small open pocket 31 indicated by the shaded triangular area in the drawing. A small lappet 32 connected to the base of the unglued triangular area 30 of the flap is provided with two folding crease lines 33, 34 defining a blocking strip 38 of material therebetween, allowing the lappet to be folded to form a dogleg configuration illustrated in FIGS. 3 and 4 and provide a stiffening member as described below.

Referring primarily to FIGS. 3 and 4, there is shown the stiffening mechanism 50 for releasably holding the structure 11 in the deployed, open or extended configuration. The mechanism is formed by the cooperating folded lappet 32 and the pocket 31 formed by the unglued triangular area 30 existing under the flap 28 glued against the side wall 16,17 along its top edge 42.

When the folded lappet 32 is intimately wedged into the pocket 31 as shown in the drawing of FIG. 3, it acts as a stiffening member that prevents the side wall from collapsing and the whole structure from folding down. When the lappet is removed from the pocket as shown in FIG. 4, the side wall can fold along its oblique creases allowing the box to collapse. The lappet extends into a floating handling tab 35 to be easily grasped in order to manipulate the lappet.

Once the container has been collapsed, it can be folded along a pair of parallel folding lines 36, 37 which run front-to-back through the middle of the structure into the convenient transport package illustrated in FIG. 4 for storage, or shipment. The parallely spaced apart folding lines provide enough room to accommodate the folded front, back and side walls between the folded halves of the bottom piece 12 in a substantially planar manner. Thus the entire structure can conveniently and inexpensively packaged, shipped and stored in a less bulky configuration.

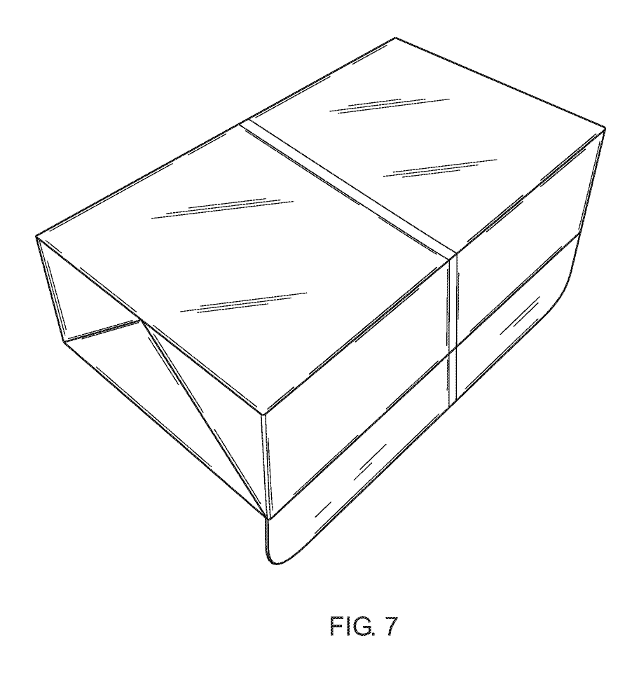

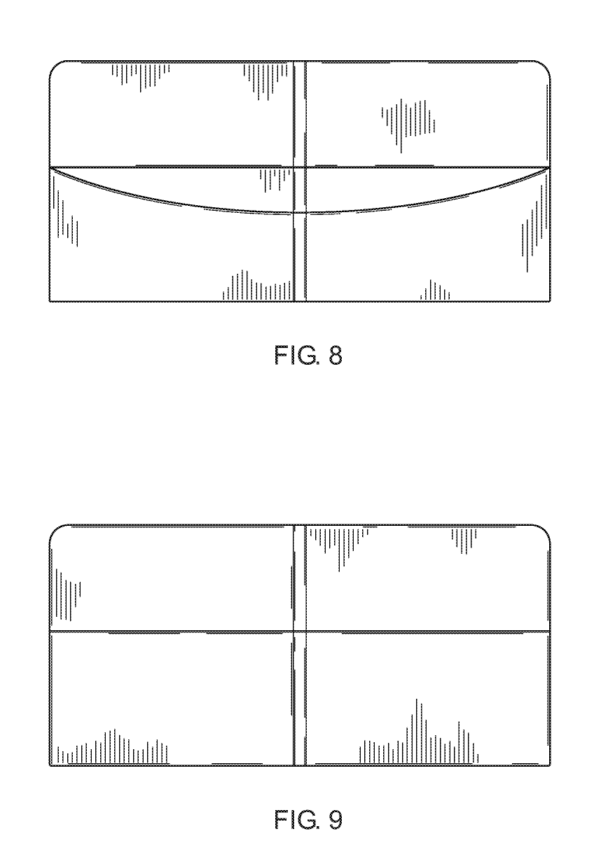

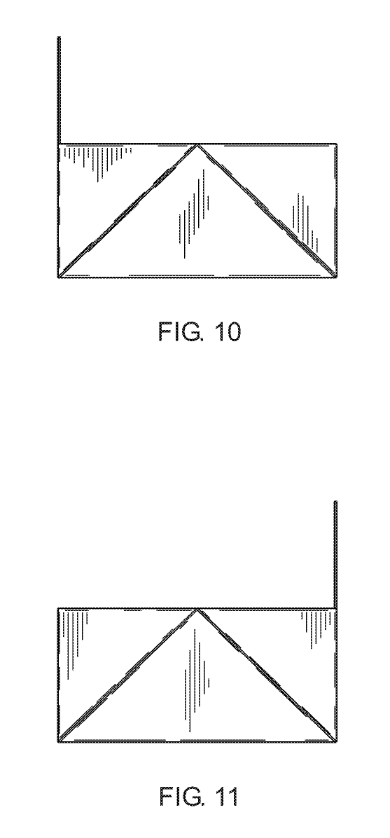

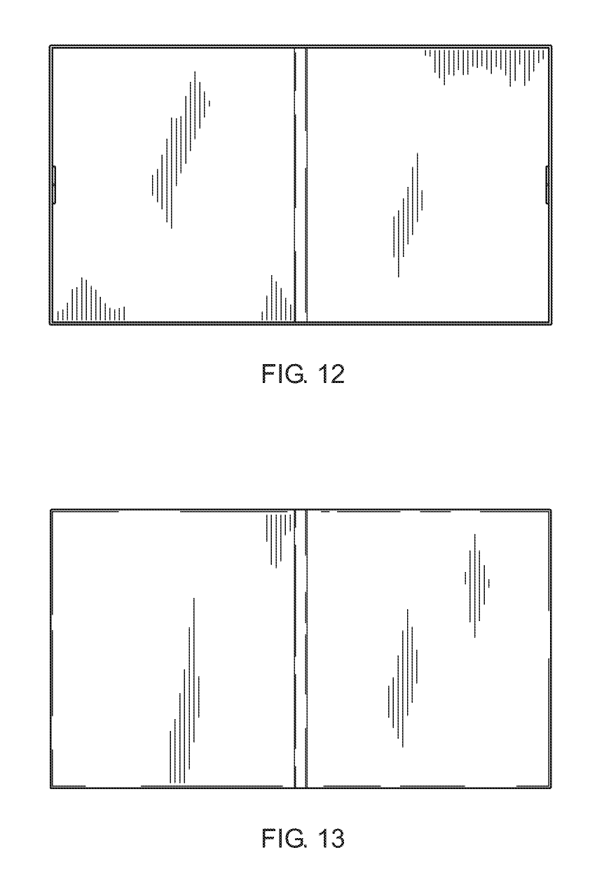

FIGS. 6-13 show the ornamental views of my cat litter box in the open or extended configuration.

While the exemplary embodiments of the invention have been described, modifications can be made and other embodiments may be devised without departing from the spirit of the invention and the scope of the appended claims.

What is claimed is:

1. A collapsible structure which comprises:
a front wall;
a back wall;
a pair of side walls spanning said front and back walls about four orthogonal corners;
each of said side walls having an upper edge and a pair of oblique creases each extending from a lower part of one of said corners to a central region of said upper edge; and
a removable stiffening member preventing each of said side walls from folding down along said creases.

2. The structure of claim 1, wherein each of said side walls further includes:
a flap extending from said upper edge and fixedly folded over a triangular top portion of said wall delineated by said creases; and
said stiffening member being wedged between said flap and said triangular portion.

3. The structure of claim 2, wherein said triangular top portion and said flap cooperatively form a pocket shaped and dimensioned to intimately accept said stiffening member.

4. The structure of claim 2, which further comprises a lappet hingedly connected to said flap, wherein said lappet comprises said stiffening member.

5. The structure of claim 4, wherein said lappet comprises:
a pair of parallel folding lines defining a blocking strip therebeween; and
a floating handling tab.

6. The structure of claim 5, wherein said stiffening member comprises said blocking strip.

7. The structure of claim 1, which further comprises a rectangular bottom joined to said walls along its periphery.

8. The structure of claim 7, which further comprises a cover hingedly connected to an upper edge of one of said front and back walls.

9. The structure of claim 8, which further comprises a seal for sealing said cover over said collapsed structure.

10. The structure of claim 9, wherein said seal extends along the entire width of said structure.

11. The structure of claim 9, which further comprises a layer of granular litter material over said bottom.

12. The structure of claim 8, which further comprises a first folding crease extending across a median portion of said cover, front wall, back wall and bottom.

13. The structure of claim 12, which further comprises a second folding crease parallel to said first folding crease and spaced sufficiently apart therefrom to allow said structure collapsed along said oblique lines and said periphery to be folded about said first and second creases in a substantially planar manner.
